(19) United States
(12) Patent Application Publication
(10) Pub. No.: US 2022/0203342 A1
(43) Pub. Date: Jun. 30, 2022

(54) A CATALYST FOR HYDROTREATING HYDROCARBON OIL AND A METHOD OF HYDROTREATING HYDROCARBON OIL USING THE CATALYST

(71) Applicant: Nippon Ketjen Co., Ltd, Tokyo (JP)

(72) Inventors: Kenji NONAKA, Ehime (JP); Hirotaka MORIMOTO, Ehime (JP); Ryuichi OSHITA, Ehime (JP)

(21) Appl. No.: 17/609,952

(22) PCT Filed: Apr. 28, 2020
(86) PCT No.: PCT/JP2020/018149

§ 371 Date: Nov. 9, 2021

(30) Foreign Application Priority Data
May 15, 2019 (JP) 2019-091779

(51) Int. Cl. B01J 27/19; B01J 35/10; B01J 21/04; C10G 45/08

(52) U.S. Cl. CPC B01J 27/19; B01J 35/1038; B01J 35/1061; B01J 35/1014; B01J 35/1019; C10G 2300/4018; C10G 45/08; C10G 2300/202; C10G 2300/308; C10G 2300/301; B01J 21/04

(57) ABSTRACT

[Problem to be Solved] To provide a catalyst having hydrotreatment (hydrogenation, desulfurization and denitrogenation) performance that is equal to or superior to the prior art, as a hydrotreating catalyst for hydrocarbon oils, and a hydrotreating process for hydrocarbon oils using the catalyst. [Means to Solve the Problem] A hydrotreating catalyst for hydrocarbon oils comprising, at least one metal selected from the group 6 of the periodic table, at least one metal selected from the groups 8 to 10 of the periodic table, and optionally further phosphorus and/or boron as catalytic active components supported on an inorganic porous support based on alumina, wherein the inorganic porous support comprises, as constituent components thereof, silica in an amount of less than 1% by mass with respect to the mass of the oxide and a metal of the group 4 of the periodic table in an amount of less than 13% by mass as an oxide; wherein the metal of the group 4 of the periodic table is highly dispersed in the inorganic porous support, a degree of dispersion thereof is shown by that no peak is substantially observed in the wave number range of 100 to 200 cm⁻¹ by Raman spectroscopy and that no crystal is substantially observed by X-ray diffraction analysis; wherein the hydrotreating catalyst has a specific surface area of 100 to 300 m²/g, a pore volume of 0.2 to 0.5 ml/g, an average pore diameter of 6 to 10 nm, and a NO adsorption amount of 4.5 cm³/ml or more as catalytic characteristics; and wherein no crystals derived from the metal oxide salts of the group 6 of the periodic table are not substantially observed by X-ray diffraction analysis.

### TECHNICAL FIELD

The present invention relates to a hydrogenation catalyst for removing impurities such as sulfur and nitrogen contained in hydrocarbon oil and a method of using the same.

### BACKGROUND ART

In view of the global trend of air quality improvement in recent years, further performance improvement is required from hydrogenation catalysts that perform hydrorefining such as desulfurization, denitrogenation, etc., of distillate oil as main fuels. Common hydrotreating catalysts for hydrocarbon oils are inorganic heat-resistant supports such as alumina or silica having molybdenum and a hydrogenation-active metal component such as cobalt or nickel supported on it.

In recent years, however, not only a mere improvement in desulfurization performance, but also stability of the catalyst performance and economy for contributing to the efficiency of the hydroprocessing unit operation are required from catalysts. As one answer to such a demand, a catalyst technology using a composite oxide as a support has been proposed.

Patent Document 1 discloses a hydrodesulfurization catalyst for petroleum hydrocarbon oil comprising a support containing silica, titania, zirconia, boria, etc., other than alumina, in an amount of 4 to 8% by mass, supporting nickel and/or cobalt and molybdenum thereon. However, the content of components other than alumina is small, and the effect as a composite oxide support is not likely to be exhibited in catalytic activity.

Patent Document 2 relates to a hydrodesulfurization catalyst for hydrocarbon oils comprising silica-titania-alumina composite oxide supports supporting metal components of Group VIA or Group VIII of the periodic table specified by X-ray diffraction analysis. However, since crystals derived from titanium remain in the used support, there is a problem in the dispersibility of the components of the composite oxide that affects the catalytic activity.

Patent Document 3 discloses a hydrotreating catalyst for hydrocarbon oils containing molybdenum and/or tungsten, cobalt and/or nickel, and a carbon derived from an organic acid with respect to 100 parts by mass of the catalyst on an inorganic oxide support. However, since there is no reference to high dispersion performance of the inorganic oxide component in the support, the catalytic performance has not been sufficiently improved.

### CITATION LIST

### Patent Literature

[PTL1:] JP-A-2005-254141
[PTL2:] JP-A-2011-72928
[PTL3:] JP-A-2016-203074

### SUMMARY OF INVENTION

### Problems to be Solved by the Invention

It is an object of the present invention to provide a catalyst having hydrotreating (hydrogenation, desulfurization and denitrogenation) performance and activity stability that are equal to or superior to the prior art, as a hydrotreating catalyst for hydrocarbon oils, and a hydrotreating process for hydrocarbon oils using the catalyst.

### Means for Solving the Problem

The present inventors have conducted much diligent research in light of the aforementioned problems of the prior art, with particular focus on the improvement in dispensability of composite oxide components as a catalyst support, a supporting method of active metal components and optimization of the pore structure. As a result, we have found that a catalyst obtained by supporting a hydrogenation-active component on an inorganic porous support containing a specific amount of silica, a group 4 metal of the periodic table which is highly dispersed in the inorganic porous support, is highly effective for hydrotreating of hydrocarbon oils to complete the present invention.

In other words, the present invention is a hydrotreating catalyst for hydrocarbon oils comprising, as constituent components thereof, at least one metal selected from the group 6 of the periodic table, at least one metal selected from the groups 8 to 10 of the periodic table, and optionally further phosphorus and/or boron as catalytic active components supported on an inorganic porous support based on alumina, wherein the inorganic porous support comprises silica in an amount of less than 1% by mass with respect to the mass of the oxide and a metal of the group 4 of the periodic table in an amount of less than 13% by mass as an oxide; wherein the metal of the group 4 of the periodic table is highly dispersed in the inorganic porous support, a degree of dispersion thereof is shown by that no peak is substantially observed in the wave number range of 100 to 200 cm⁻¹ by Raman spectroscopy and that no crystal is substantially observed by X-ray diffraction analysis; wherein the hydrotreating catalyst has a specific surface area of 100 to 300 m²/g, a pore volume of 0.2 to 0.5 ml/g, a mean pore diameter of 6 to 10 nm, and a NO adsorption amount of 4.5 cm³/ml or more as catalytic characteristics; and wherein no crystals derived from the metal oxide salts of the group 6 of the periodic table are not substantially observed by X-ray diffraction analysis.

In addition, in the hydrotreating catalyst of the present invention, the supported amount of the metal selected from the group 6 of the periodic table is 15 to 30% by mass and the supported amount of the metal selected from the groups 8 to 10 of the periodic table is 0.5 to 5% by mass based on the catalyst oxide.

And, the hydrotreating catalyst for hydrocarbon oils of the present invention comprises 0.5 to 5% by mass of phosphorus and/or boron based on the catalyst oxide.

Furthermore, the hydrotreating method of hydrocarbon oils of the present invention consists in that the hydrogenation catalyst of the present invention is brought into contact with a hydrocarbon oil under conditions of a reaction temperature of 300 to 450° C., a hydrogen partial pressure of 1 to 20 MPa, a liquid hourly space velocity of 0.1 to 10 hr⁻¹, and a hydrogen/oil ratio of 50 to 1,200 Nm³/kl.

### Effect of the Invention

Use of the hydrotreating catalyst of the invention does not only allow impurities such as sulfur and nitrogen to be removed efficiently and a long-term stable activity to be shown, but also allow an efficient and economical operation of a hydroprocessing unit.

### MODES FOR CARRYING OUT THE INVENTION

(1) Support

We will describe the present invention in detail below.

The support to be used for the catalyst of the present invention is a composite oxide containing a specified amount of silica and an oxide of a metal of the group 4 of the periodic table with alumina as the substrate.

As the silica starting material, various types of silicon compounds such as alkali metal silicates, alkoxysilanes, silicon tetrachloride, orthosilicates, silicone, silica sol, silica gel and the like may be used. In addition, as the alumina starting materials, aluminum hydroxides (bayerite, gibbsite, diaspore, boehmite, pseudoboehmite and the like), chlorides, nitrates, sulfates, alkoxides, alkali metal aluminates and other inorganic salts, organic salts or alumina sol may be used.

On the other hand, the starting materials for the oxide of the metal of the group 4 of the periodic table include oxides, oxychloride, chlorides, hydroxides, hydrides, nitrates, carbonates, oxysulfate, sulfates and organic acid salts. Titanium, zirconium, and hafnium may be used as elements of the group 4 of the periodic table. However, titanium and zirconium are preferably used, and titanium is particularly preferred from the viewpoint of activity and economic performance.

A composite oxide support containing a specific amount of silica and a metal of the group 4 of the periodic table is obtained by calcining a hydrate containing a silica-metal of the group 4 of the periodic table prepared by a coprecipitation method or kneading method.

The hydrate may be prepared by any of various methods, such as coprecipitation of the silica and alumina starting materials and the group 4 metal compound, kneading of an alumina hydrate, silicon compound and the group 4 metal compound, mixing of an alumina-group 4 metal hydrate and a silicon compound, or mixing of a silicon compound-group 4 metal and kneading of an alumina hydrate. From the perspective of improving dispersibility of components of a composite oxide, however, coprecipitation is particularly preferable.
The silica component is preferably less than 1% by mass, preferably 0.01 to 0.99% by mass and more preferably 0.02 to 0.95% by mass based on composite oxide supports. On the other hand, the oxide of the metal of the group 4 of the periodic table is less than 13% by mass, preferably 7 to 12.9% by mass, and more preferably 8.1 to 12% by mass.

The hydrate containing silica-group 4 metal oxide of the periodic table is added with an aqueous solution of hydrochloric acid, sulfuric acid, nitric acid an organic acid (formic acid, acetic acid, propionic acid, oxalic acid, malonic acid, malic acid, tartaric acid, citric acid, gluconic acid or the like), ammonia or sodium hydroxide to control the pore structure or to improve dispersibility of the components and formability of the hydrate as necessary, and kneaded with addition of various types of cellulose-based molding aids to mold to the desired shape (pellets, spheres, extruded body, etc.). The molded article is usually calcined in air at a temperature of 450° C. to 750° C. (not the atmospheric temperature but rather the temperature of the molded article), preferably 490° C. to 720° C. and more preferably 500° C. to 700° C. for 0.1 to 5 hours and preferably 0.5 to 3 hours to produce a composite oxide support.

The composite oxide support has preferably an absorption edge wavelength of the absorption peak derived from the group 4 metal of the periodic table measured by ultraviolet spectroscopy (the maximum wavelength in which a spectral intensity value (K-M value) after Kubelka-Munk conversion is 0.3 or higher) at 350 nm or less, preferably at 348 nm or less, and the maximum wavelength at 323 nm or less, preferably at 320 nm or less in which the K-M value is 1.5 or less.

A composite oxide support having a long, gentle K-M curve with an absorption edge wavelength outside this range has insufficient dispersion of metal oxides of the group 4 of the periodic table. Therefore, the catalytic activity after supporting the active components will not improve.

The ultraviolet spectral analysis of the composite oxide support was performed by using an ultraviolet-visible spectrophotometer (manufactured by Shimadzu Corporation: UV-2450 (product name)) attached with an integrating sphere attachment device for the UV-2200 series for the diffuse reflection method (ISR-2200 (product name)). In addition, a white board of barium sulfate was used for background measurement. Table 1 shows the measurement conditions.

TABLE 1
UV spectral analysis conditions

| Sample weight | 2.4 | g |
|---|---|---|
| Sample pretreatment | After heating at 450° C. for 30 minutes, | |
| | the sample was cooled for 15 minutes at | |
| | room temperature in a desiccator | |
| Measurement | Start wavelength 500 nm | |
| wavelength range | End wavelength 200 nm | |
| Scanning speed | 100 | nm/min |
| Data acquisition interval | 0.1 | nm |
| Slit width | 5.0 | nm |
| Light source switching | 340 | nm |
| wavelength | | |

The measured data was subjected to Kubelka-Munk conversion (K-M conversion) using the Kubelka-Munk function, and the maximum wavelength (absorption edge wavelength) with a spectral intensity value (K-M value) of 0.3 or higher and the maximum wavelength with the K-M value of 1.5 or lower were calculated.

Hydrogenation-active components were added to the support obtained by the above steps, and after drying, further heating treatment was provided as necessary to support the hydrogenation-active components.

The method of addition is not particularly restricted, and for example, various industrial methods such as impregnation, coating or spraying may be applied, although impregnation methods are preferred from the viewpoint of manageability and addition efficiency. The impregnation methods of adsorption, equilibrium adsorption, pore filling method, incipient wetness, evaporation to dryness and spraying may all be applied to the invention of the present application. However, pore filling method is preferred from the viewpoint of workability.

There are no particular restrictions on the order of adding the hydrogenation-active components and they may be added in succession or simultaneously. In the case of impregnation method, a solution in which each component is dissolved in various polar organic solvents, water, mixtures of water-organic solvents may be used, but the most preferable solvent is water.

(2) Supported Components

Among the hydrogenation active components to be supported onto the support, the group 6 element of the periodic table is at least one selected from chromium, molybdenum and tungsten. Any one of these elements can be used alone, but molybdenum and tungsten, and especially molybdenum, are preferred from the viewpoint of economy and activity. They may also be used in combination, depending on the reactivity of the feedstock and the operating conditions of the reactor. Examples of the combination include chromium-molybdenum, chromium-tungsten, molybdenum-tungsten and chromium-molybdenum-tungsten.

The supported amount is 15 to 30 mass %, preferably 17 to 28 mass %, and more preferably 18 to 25 mass % as the total of the oxides of the group 6 element of the periodic table based on the mass of the oxide catalyst. When the amount is less than 15 mass %, the catalytic activity is low, and there is no increase in activity even when the amount exceeds 30 mass %.
The raw materials of the group 6 elements of the periodic table include chromates, molybdates, tungstates, trioxides, halides, heteropoly-acids, heteropoly-acid salts, etc.

The group 8 to 10 elements of the periodic table as hydrogenation active components include iron, cobalt and nickel.

Any one of these elements may be used alone, but cobalt and nickel are preferred from the viewpoint of economy and activity. They may also be used in combination, depending on the reactivity of the feedstock and the operating conditions of the reactor. Examples of the combination include iron-cobalt, iron-nickel, cobalt-nickel and iron-cobalt-nickel.

The supported amount is 0.5 to 5 mass %, preferably 1 to 4.8 mass %, and more preferably 2 to 4.5 mass % as the total of the oxides of the group 8 to 10 elements of the periodic table based on the mass of the oxide catalyst. When the amount is less than 0.5 mass %, the catalytic activity is low, and there is no increase in activity even when the amount exceeds 5 mass %.

Compounds of iron, cobalt and nickel used for supporting include oxides, hydroxides, halides, sulfates, nitrates, carbonates, organic acid salts, etc. When an impregnating solution of the hydrogenation-active components is to be prepared, the group 6 elements of the periodic table or the group 8 to 10 elements of the periodic table may be prepared alone, or both of them may be mixed as a homogeneous solution.

In order to adjust the pH of the solution and increase the solution stability and catalyst hydrogenation activity, ammonia water, hydrogen peroxide water, nitric acid, sulfuric acid, hydrochloric acid, phosphoric acid, boric acid, hydrofluoric acid or the like may be added to the impregnating solution of the hydrogenation-active components, as necessary.

Phosphoric acids and boric acids may also be added as a catalyst component, and in this case, the addition range is 0.5 to 5 mass %, preferably 0.8 to 4.5 mass % and more preferably 1 to 4 mass % as oxide based on the mass of the oxide catalyst. In addition, all or part of phosphoric acids and boric acids may be added during the process of preparing the silica-alumina-group 4 metal oxide support of the periodic table, in addition to adding to the impregnating solution of hydrogenation-active components.

In addition, in order to improve stability of the impregnating solution and dispersibility of hydrogenation-active components after supporting, water-soluble organic additives as shown below may be added in impregnating solution of hydrogenation-active components.

Organic additives are selected from polyhydric alcohols and their ethers, esters of polyhydric alcohols or ethers, saccharides, carboxylic acids and their salts, amino acids and their salts, various chelating agents and the like.

Examples of polyhydric alcohols and their ethers include polyhydric alcohols such as ethylene glycol, diethylene glycol, triethylene glycol, propylene glycol, isopropylene glycol, dipropylene glycol, tripropylene glycol, butanediols (1,2-, 1,3-, 1,4-, 2,3-), pentanediols (for example, 1,5-, including other isomers), 3-methyl-1,5-pentanediol, neopentyl glycol, hexanediol (for example, 1,2- and 1,6-, including other isomers), hexylene glycol, polyvinyl alcohol, polyethylene glycol (average molecular weight: 200-600), polypropylene glycol (only water-soluble), glycerin, trimethylolethane, trimethylolpropane, hexanetriol (for example, 1,2,6-, including other isomers), erythritol and pentaerythritol, as well as their ethers (monoethers, diethers and triethers which are water-soluble, selected from among methyl, ethyl, propyl, isopropyl, butyl, isobutyl, secondary butyl and tertiary butyl ethers).

Examples of esters of polyhydric alcohols or ethers include esters of the aforementioned polyhydric alcohols or ethers (monoesters, diesters and triesters with formic acid, acetic acid and the like, which are water-soluble).

Examples of saccharides include saccharides such as glucose, fructose, isomerized sugars, galactose, maltose, lactose, sucrose, trehalose, starch, dextrin, pectin, glycogen, curdlan and the like.

Examples of carboxylic acids and their salts include carboxylic acids such as formic acid, acetic acid, propionic acid, oxalic acid, malonic acid, succinic acid, maleic acid, fumaric acid, tartaric acid, citric acid (anhydride, monohydrate), malic acid, gluconic acid and glutaric acid, and salts thereof.

Examples of amino acids and their salts include amino acids such as aspartic acid, alanine, arginine, glycine and glutamic acid, and salts thereof.

Examples of different chelating agents include various chelating agents such as ethylenediamine (EDA), diethylenetriamine (DETA), triethylenetetramine (TETA), tetraethylenepentamine (TEPA), pentaethylenehexamine (PEHA), ethylenediaminetetraacetic acid (EDTA), hydroxyethylethylenediaminetriacetic acid (HEDTA), diethylenetriaminepentaacetic acid (DTPA), triethyltetraminehexaacetic acid (TTHA), hydroxyethyliminodiacetic acid (HIDA), 1,3-propanediaminetetraacetic acid (PDTA), 1,3-diamino-2-hydroxypropanetetraacetic acid (PDTA-OH), trans-1,2-cyclohexanediaminetetraacetic acid (CyDTA), glycol etherdiaminotetraacetic acid (GEDTA), nitrilotriacetic acid (NTA), dihydroxyethylglycine (DHEG) and (S,S)-ethylenediamine-N,N′-disuccinic acid (EDDS).

The organic additives above may be used alone or in appropriate combinations.

The amount of organic additives to be added is 0.01 to 3 times, preferably 0.03 to 2.8 times and most preferably 0.05 to 2.5 times the total number of moles of the group 6 elements of the periodic table and the group 8 to 10 elements of the periodic table. No catalyst performance is improved at less than a 0.03-fold molar amount. No further increase in activity is obtained with a greater than 3-fold molar amount.

After the impregnation solution containing the hydrogenation active component is added to the compound oxide support, a completed catalyst can be obtained by drying the mixture, for example, in air at a substance temperature of 30 to 250° C. for 0.1 to 3 hours, and by calcining optionally at 450 to 630° C., preferably at 500 to 600° C. for 0.5 to 3 hours.

(3) Properties of a Completed Catalyst

In order for a completed catalyst to exhibit satisfactory catalyst performance, it preferably has the following physical properties and pore structure.

Specifically, the average pore diameter is 6 to 10 nm, preferably 6.5 to 9.5 nm, and more preferably 7 to 9 nm. If the average pore diameter is less than 6 nm, the diffusion of hydrocarbon oil into the pores is insufficient, and if the diameter exceeds 10 nm, the specific surface area is reduced, thereby lowering the catalyst performance.

Further, it is preferred that the total pore volume is 0.2 to 0.5 ml/g. A more preferred range is 0.25 to 0.45 ml/g. A total pore volume of less than 0.2 ml/g is insufficient for diffusing the hydrocarbon oil into the pores, and if the volume is more than 0.5 ml/g the absolute weight of the catalyst loaded into the reactor is so light that sufficient catalytic performance cannot be exhibited.

As an indicator showing the uniformity of the catalyst pores, it is desirable that the pore structure of the catalyst is such that the volume of the pores with their diameters kept in a range of between the average pore diameter +1 nm and −1 nm accounts for 50 to 90% of the total pore volume. A preferred range is 60 to 85%. If it is less than 50%, there will be an increased proportion of micropores that do not participate in the reaction, and also large pores with low surface area, while if it is greater than 90%, this will inhibit diffusion in the pores of hydrocarbon oil that has a relatively large molecular size, potentially lowering the catalytic activity.

The pore size distribution of the catalyst of the present invention is the monomodal distribution centered around the mean pore diameter and its vicinity.

The specific surface area is preferably 100 to 300 m²/g, more preferably 150 to 290 m²/g and even more preferably 180 to 250 m²/g. If it is less than 100 m²/g, the catalyst performance will be inadequate, and if it is greater than 300 m²/g, the mean pore diameter will be too small, thereby likely to result in plugging of the pores during the reaction.

In the meantime, the value of the pore structure (pore volume, average pore diameter, pore size distribution, etc.) is obtained by the mercury penetration method (contact angle 140 degrees, surface tension 480 dyn/cm), and the value of the specific surface area is obtained by the BET method, respectively. To measure the pore structure and the specific surface area of a completed catalyst and to measure the supported amount of hydrogenation active components, the completed catalyst is treated in air at 450° C. for 1 hour to remove moisture and organic materials contained therein before measurement, and the analysis and measurement values obtained here are used as the value for the mass of oxide catalyst. Further, a fluorescent X-ray analyzer was used for measurement of hydrogenation-active components and support constituting components.

As chemical properties of a completed catalyst, the NO adsorption amount after the sulfidation treatment is preferably 4.5 cm³/ml or more. If it is less than 4.5 cm³/ml, the number of catalyst active sites is too small to achieve desired catalytic performance.

In addition, it is necessary for a completed catalyst to substantially have no observed peak in a wave number range of 100 to 200 cm⁻¹, in particularly, of 120 to 160 cm⁻¹ by a laser Raman spectrometer. When a peak appears in this range, it means that the periodic table group 4 metal, which is a component of the composite oxide support, aggregates without being highly dispersed, that is, without being uniformly dispersed. As a result, it is considered that the catalyst activity and active stability are decreased by promoting the aggregation of supported hydrogenation active component.

On the other hand, it is also important that no diffraction peak derived from crystals of the periodic table group 4 metal oxide (around 2θ=25 to 30°) and of the periodic table group 6 metal oxide salt (around 2θ=25 to 35°) is substantially observed. TiO₂, ZrO₂, HfO₂, as metal oxides of the group 4 of the periodic table, and FeMoO₄, CoMoO₄, NiMoO₄, FeWO₄, CoWO₄, NiWO₄ and the like, as metal oxide salts of the group 6 of the periodic table, can be exemplified, respectively. The presence of these diffraction peaks indicates the aggregation of support constituent components and supported hydrogenation active components, which causes a decrease in catalyst activity and activity stability.

In addition, what is meant by “not observed substantially” above refers to that even in the case where a peak from a target substance appears in the measurement range in which the target substance appears, the maximum value and the minimum value on the baseline are determined in the range of 20 times the half width of the peak before and after the peak, and the peak value of the target substance does not exceed three-times the value of the half value of the difference.

The NO adsorption amount of the catalyst was measured according to the procedure described below.

The catalyst sample sieved with 200 to 330 meshes was pretreated at 450° C. for 1 hour, weighed about 0.1 g thereof to be packed into a sample tube, and a 2.7% H₂S/30% H₂/Ar gas was circulated for 30 minutes at 50° C., and after increasing the temperature to 400° C. in 35 minutes, sulfurization treatment was performed at 400° C. for 2 hours. Thereafter, the mixed gas stream was cooled down to 50° C. to be changed for a He stream, and the NO adsorption amount of the catalyst was measured by a pulse method (TCD detector) using 15% NO/He gas. The NO adsorption amount was obtained by multiplying the measured NO adsorption amount per unit weight of catalyst (cm³/g) by the compacted bulk density of the catalyst (g/ml) to obtain the NO adsorption amount per unit catalyst volume (cm³/ml).

The Raman spectroscopic analysis of the catalyst was performed by using a laser Raman spectroscopy apparatus (DXR series (trade name)) manufactured by Thermo Fisher Scientific Co., Ltd. at room temperature with respect to a crushed catalyst sample (about 0.1 g) inserted between slide glasses under the conditions shown in Table 2.

TABLE 2
Raman spectroscopic analysis conditions

| Laser wavelength | 532 | nm |
|---|---|---|
| Laser intensity | 10 | mW |
| Measuring range | 1,800 to 100 cm⁻¹ | |
| Objective lens magnification | 10 | times |
| Slit size | 50 | μm pinhole |
| Exposure time | 1 | second |
| Number of exposures | 1,000 | times |

The X-ray diffraction analysis for the catalyst was performed using a powder X-ray diffractometer (X'PERT PRO (trade name)) manufactured by PANalytical, under the conditions shown in Table 3 to check the presence or absence of a diffraction peak derived from oxides of the group 4 of the periodic table and metal oxide salts of the group 6 of the periodic table.

TABLE 3
XRD analysis conditions

| | |
|---|---|
| Starting angle | 3° |
| Ending angle | 80° |
| Step size | 0.0167° |
| Step time | 50.165 seconds |
| Scanning speed | 0.0422°/second |

A completed catalyst is usually used after pre-sulfurization, and the pre-sulfurization may be conducted either inside or outside the reactor.

The pre-sulfurization method employed may be sulfidizing with a liquid phase using a kerosene or gas oil fraction containing sulfur in a heated state under a hydrogen atmosphere, or using an appropriate amount of a sulfidizing agent such as carbon disulfide, butanethiol, dimethyl disulfide (DMDS) or ditertiary nonylpolysulfide (TNPS) added to such an oil, or a gas phase sulfurization method using hydrogen sulfide or carbon disulfide as the sulfidizing agent in a heated hydrogen stream.

(4) Hydrocarbon Oil

The hydrocarbon oil for hydrotreating by the catalyst of the invention is a distilled oil with a 90% boiling point temperature of no higher than 560° C., preferably no higher than 540° C., and an initial boiling point of 100° C. or higher, preferably 150° C. or higher, based on ASTM D-86.

Specific examples include mainly petroleum-based naphtha, straight-run kerosene, straight-run gas oil, heavy gas oil, vacuum gas oil and heavy vacuum gas oil, but also included are kerosene and gas oil fractions (light cycle oil or coker gas oil) obtained from hydrocrackers, thermal crackers or fluidized catalytic crackers and kerosene and gas oil fractions from heavy oil direct desulfurizers, as well as kerosene and gas oil-corresponding fractions from coal or from animal and vegetable biomass and any blended oils comprising the aforementioned fractions.

Meanwhile, it is desirable that the content of metals such as vanadium and nickel in the feedstock to be processed is 5 mass ppm or less, preferably 1 mass ppm or less, and that the carbon residue content is 1 mass % or less, preferably 0.9 mass % or less. A heavy oil such as long residue, short residue, solvent deasphalted oil, coal liquefaction oil, shale oil or tar sand oil can also be mixed with the distillate oil to be hydroprocessed, for fulfilling the metal content and carbon residue content.

(5) Hydrotreating Method

The hydrotreating catalyst of the present invention may be used in various hydrotreatment reactions in which the hydrocarbon oils are subjected to hydrogenation, hydrodesulfurization, hydrodenitrogenation, hydrodeoxygenation, hydrocracking, hydroisomerization or the like in the presence of hydrogen, in a reactor such as a fixed bed, moving bed or the like.

A more preferred use for the hydrotreating catalyst of the present invention is desulfurization or denitrogenation of a petroleum-based distilled oil, and especially reduction of the sulfur content in a kerosene or gas oil fraction to no greater than 80 ppm by weight and more preferably no greater than 10 ppm by weight.
For use in a hydrotreating apparatus, the reaction conditions will depend on the type of feedstock but will generally be a hydrogen partial pressure of 1 to 20 MPa and preferably 3 to 18 MPa, a hydrogen/oil ratio of 50 to 1,200 Nm³/kl and preferably 100 to 1,000 Nm³/kl, a liquid hourly space velocity of 0.1 to 10 h⁻¹ and preferably 0.5 to 8 h⁻¹, and a reaction temperature of 300° C. to 450° C., and preferably 320° C. to 430° C.

### EXAMPLES

The present invention is further illustrated by the following examples. However, the following examples do not limit the present invention at all.

### Preparation of Catalyst

### Example 1

Aluminum sulfate solution (8.1 mass % in terms of Al₂O₃), sodium aluminate solution (21.6 mass % in terms of Al₂O₃), and titanyl sulfate solution (13.6 mass % in terms of TiO₂) as well as water glass were added and mixed to prepare a silica-titania-alumina hydrate gel (silica/titania/alumina mass ratio: 0.2/9.8/90.0). After separating hydrate from the solution, washing out and removing impurities using warm water, peptizing by adding an organic acid, heat kneading using a kneader to adjust the water content to 67%, extruding and molding, and calcining in air at 600° C. for 1.5 hours to obtain a silica-titania-alumina support.

The support was impregnated with an aqueous solution containing molybdenum trioxide, basic cobalt carbonate, phosphoric acid, and citric acid monohydrate (0.1 fold molar amount with respect to the amount of substance of molybdenum and cobalt) so as to let the support to contain 24 mass % of molybdenum trioxide, 4 mass % of cobalt oxide and 2 mass % of phosphorus oxide based on the mass of the oxide catalyst. Two hours later in 120° C., the support was subjected to hot air drying treatment in air and after calcining at a substance temperature of 500° C. for 1.5 hours, a catalyst A was obtained. Table 4 shows the physical properties and chemical composition of the catalyst A.

### (Example 2

Catalyst B was prepared by the same method as Example 1, except that the organic additives, citric acid monohydrate and polyethylene glycol (average molecular weight: 200) to be added to the impregnating solution in Example 1 were used in 0.1 fold molar amount and 0.2 fold molar amount to the total number of moles of molybdenum and cobalt, respectively. Table 4 shows the physical properties and chemical composition of the catalyst B.

### Example 3

Catalyst C was prepared by the same method as Example 1, except that the addition amount of titanyl sulfate was modified in Example 1 to prepare a silica-titania-alumina hydrate gel (silica/titania/alumina mass ratio: 0.2/8.2/91.6). Table 4 shows the physical properties and chemical composition of the catalyst C.

### Example 4

Catalyst D was prepared by the same method as Example 1, except that the addition amount of titanyl sulfate was modified in Example 1 to prepare a silica-titania-alumina hydrate gel (silica/titania/alumina mass ratio: 0.2/12.7/87.1). Table 4 shows the physical properties and chemical composition of the catalyst D.

### Example 5

Catalyst E was prepared by the same method as Example 1, except that an impregnating solution to which no organic additive was added was used. Table 4 shows the physical properties and chemical composition of the catalyst E.

### Example 6

Catalyst F was prepared by the same method as Example 1, except that basic cobalt carbonate was changed to basic nickel carbonate as an oxide nickel based on the mass of the oxide catalyst. Table 4 shows the physical properties and chemical composition of the catalyst F.

### Comparative Example 1

Catalyst G was prepared by the same method as Example 1, except that the roasting temperature at the time of preparation of the silica-titania-alumina support was 800° C. Table 5 shows the physical properties and chemical composition of the catalyst G.

### Comparative Example 2

Catalyst H was prepared by the same method as Example 1, except that the calcination temperature after the impregnation of the active component in Example 1 was 650° C. Table 5 shows the physical properties and chemical composition of the catalyst H.

### Comparative Example 3

Catalyst I was prepared by the same method as Example 1, except that the addition amount of titanyl sulfate was changed to form a silica-titania-alumina hydrate gel (silica/titania/alumina mass ratio: 0.2/14/85.8). Table 5 shows the physical properties and chemical composition of the catalyst I.

### Comparative Example 4

Catalyst I was prepared by the same method as Example 1, except that the addition amount of titanyl sulfate was changed to form a silica-titania-alumina hydrate gel (silica/titania/alumina mass ratio: 0.2/3/96.8). Table 5 shows the physical properties and chemical composition of the catalyst J.

### Comparative Example 5

Catalyst K was prepared by the same method as Example 1, except that titanyl sulfate was not used in Example 1 to form a silica-alumina hydrate gel (silica/alumina mass ratio: 0.2/99.8) was used. Table 6 shows the physical properties and chemical composition of the catalyst K.

TABLE 4
Properties of the prepared catalysts 1

| | | | Example | Example | Example | Example | Example | Example |
|---|---|---|---|---|---|---|---|---|
| | | | 1 | 2 | 3 | 4 | 5 | 6 |
| | | | Catalyst A | Catalyst B | Catalyst C | Catalyst D | Catalyst E | Catalyst F |
| Support | SiO₂ | Mass % | 0.2 | 0.2 | 0.2 | 0.2 | 0.2 | 0.2 |
| | TiO₂ | Mass % | 9.8 | 9.8 | 8.2 | 12.7 | 9.8 | 9.8 |
| | Al₂O₃ | Mass % | Balance | Balance | Balance | Balance | Balance | Balance |
| UV analysis 1 ¹⁾ | | nm | 338 | 340 | 332 | 345 | 339 | 337 |
| UV analysis 2 ²⁾ | | nm | 310 | 311 | 305 | 320 | 312 | 313 |
| Catalyst | MoO₃ | Mass % | 24 | 24 | 24 | 24 | 24 | 24 |
| | CoO | Mass % | 4 | 4 | 4 | 4 | 4 | — |
| | NiO | Mass % | — | — | — | — | — | 4 |
| | P₂O₅ | Mass % | 2 | 2 | 2 | 2 | 2 | 2 |
| Total pore volume | | ml/g | 0.39 | 0.39 | 0.41 | 0.37 | 0.39 | 0.39 |
| Average pore | | nm | 7.8 | 7.8 | 8.1 | 7.7 | 7.8 | 7.8 |
| diameter | | | | | | | | |
| Specific surface area | | m²/g | 227 | 232 | 245 | 221 | 225 | 230 |
| Pore volume ratio ³⁾ | | % | 79 | 78 | 75 | 82 | 80 | 78 |
| NO adsorption | | cm³/ml | 5.5 | 5.8 | 5.3 | 6.1 | 5.3 | 5.0 |
| amount | | | | | | | | |
| XRD peak 1 ⁴⁾ | | — | Absence | Absence | Absence | Absence | Absence | Absence |
| XRD peak 2 ⁵⁾ | | — | Absence | Absence | Absence | Absence | Absence | Absence |
| Raman peak | | — | Absence | Absence | Absence | Absence | Absence | Absence |
| analysis ⁶⁾ | | | | | | | | |

¹⁾ Maximum wavelength (absorption edge wavelength) at which K-M value in UV analysis is 0.3 or more
²⁾ Maximum wavelength at which the K-M value in UV analysis is 1.5 or less.
³⁾ Ratio of the pore volume having an average pore diameter ±1.0 nm to the total pore volume
⁴⁾ Presence or absence of peaks derived from the group 4 metal compounds of the periodic table
⁵⁾ Presence or absence of peaks derived from the group 6 metal compounds of the periodic table
⁶⁾ Presence or absence of peaks at the wave number of 100 to 200 cm⁻¹ by Raman analysis

TABLE 5
Properties of the prepared catalysts 2

| | | | Comparative | Comparative | Comparative | Comparative | Comparative |
|---|---|---|---|---|---|---|---|
| | | | Example 1 | Example 2 | Example 3 | Example 4 | Example 5 |
| | | | Catalyst G | Catalyst H | Catalyst I | Catalyst J | Catalyst K |
| Support | SiO₂ | Mass % | 0.2 | 0.2 | 0.2 | 0.2 | 0.2 |
| | TiO₂ | Mass % | 9.8 | 9.8 | 14.0 | 3.0 | — |
| | Al₂O₃ | Mass % | Balance | Balance | Balance | Balance | Balance |
| UV analysis 1 ¹⁾ | | nm | 338 | 340 | 332 | 345 | — |
| UV analysis 2 ²⁾ | | nm | 310 | 311 | 305 | 320 | — |
| Catalyst | MoO₃ | Mass % | 24 | 24 | 24 | 24 | 24 |
| | CoO | Mass % | 4 | 4 | 4 | 4 | 4 |
| | NiO | Mass % | — | — | — | — | — |
| | P₂O₅ | Mass % | 2 | 2 | 2 | 2 | 2 |
| Total pore volume | | ml/g | 0.39 | 0.39 | 0.35 | 0.43 | 0.47 |
| Average pore | | nm | 13.6 | 8.0 | 7.5 | 8.4 | 10.2 |
| diameter | | | | | | | |
| Specific surface | | m²/g | 147 | 221 | 205 | 252 | 248 |
| area | | | | | | | |
| Pore volume ratio ³⁾ | | % | 57 | 78 | 83 | 72 | 59 |
| NO adsorption | | cm³/ml | 3.8 | 4.8 | 5.0 | 4.7 | 4.9 |
| amount | | | | | | | |
| XRD peak 1 ⁴⁾ | | — | Presence | Absence | Absence | Absence | Absence |
| XRD peak 2 ⁵⁾ | | — | Presence | Presence | Absence | Absence | Absence |
| Raman peak | | — | Presence | Absence | Presence | Absence | Absence |
| analysis ⁶⁾ | | | | | | | |

¹⁾ Maximum wavelength (absorption edge wavelength) at which K-M value in UV analysis is 0.3 or more
²⁾ Maximum wavelength at which the K-M value in UV analysis is 1.5 or less.
³⁾ Ratio of the pore volume having an average pore diameter ±1.0 nm to the total pore volume
⁴⁾ Presence or absence of peaks derived from the group 4 metal compounds of the periodic table
⁵⁾ Presence or absence of peaks derived from the group 6 metal compounds of the periodic table
⁶⁾ Presence or absence of peaks at the wave number of 100 to 200 cm⁻¹ by Raman analysis

### Hydrogenation Activity Test

Distillate Hydrotreating Test

After packing each of the catalysts of Examples 1 to 6 and Comparative Examples 1 to 5 into a fixed bed miniflow reactor, it was subjected to pre-sulfurization with a sulfurized oil obtained by adding dimethyl disulfide to straight diesel oil (corresponding to 2.5 mass % as the total sulfur content), and then it was switched to the feedstock listed in Table 6, and the hydrotreating test was conducted in which the temperature was increased by 2° C. for each 100 hours starting from the reaction temperature of 360° C. under the conditions listed in Table 7 to calculate the relative desulfurization activity based on the catalyst of Comparative Example 5 at 100 hours and 600 hours after start of the operation.

The relative desulfurization activity is the relative activity obtained based on the formulas (1) and (2) by measuring the sulfur content of each product oil obtained in the test by the fluorescent X-ray method. The test results are shown in Tables 8 and 9.

TABLE 6
Feedstock properties

| | | |
|---|---|---|
| Sulfur content | Mass % | 1.23 |
| Nitrogen content | Mass ppm | 225 |
| Density | g/cm³ at 15° C. | 0.871 |
| Distillation properties *⁾ | | |
| IBP | ° C. | 202 |
| 50% | ° C. | 294 |
| 90% | ° C. | 349 |
| FBP | ° C. | 373 |

*⁾ According to ASTM D-86 method

TABLE 7
Activity test condition 1

| | | |
|---|---|---|
| Hydrogen partial pressure | MPa | 5.0 |
| Hydrogen/oil ratio | N1/1 | 250 |
| Liquid hourly space velocity | h⁻¹ | 1.2 |
| Reaction starting temperature | ° C. | 360 |
| Reaction time | H | 100 |
| | | 600 |

$$Formula 1$$

$$Formula ( 1 )$$

$$Relative desulfurization activity = \frac{\begin{matrix}k of Examples 1 to 6 , \\ Comparative Examples 1 to 5\end{matrix}}{k of Comparative Example 5} \times 100$$

$$Formula 2$$

$$Formula ( 2 )$$

$$Hydro desulfurization reaction \text{:} \begin{matrix}k = LHSV \text{/} ( n - 1 ) \times \{ 1 \text{/} {Y}^{( n - 1 )} - 1 \text{/} {X}^{( n - 1 )} \} \\ ( Wherein n = 1.2 th )\end{matrix}$$

In the formula, LHSV is the liquid hourly space velocity, k is the reaction rate constant, n is the reaction order, X is the sulfur mass ratio in the feedstock and Y is the sulfur mass ratio in the product oil.

TABLE 8
Performance test results 1

| | Example | Example | Example | Example | Example | Example |
|---|---|---|---|---|---|---|
| | 1 | 2 | 3 | 4 | 5 | 6 |
| | Catalyst A | Catalyst B | Catalyst C | Catalyst D | Catalyst E | Catalyst F |
| Relative | 155 | 159 | 141 | 166 | 151 | 143 |
| desulfurization | | | | | | |
| activity (100 h) | | | | | | |
| Relative | 171 | 176 | 162 | 177 | 164 | 153 |
| desulfurization | | | | | | |
| activity (600 h) | | | | | | |

TABLE 9
Performance test results 2

| | Comparative | Comparative | Comparative | Comparative | Comparative |
|---|---|---|---|---|---|
| | Example 1 | Example 2 | Example 3 | Example 4 | Example 5 |
| | Catalyst G | Catalyst H | Catalyst I | Catalyst J | Catalyst K |
| Relative | 84 | 127 | 132 | 118 | 100 |
| desulfurization | | | | | |
| activity (100 h) | | | | | |
| Relative | 67 | 122 | 119 | 114 | 100 |
| desulfurization | | | | | |
| activity (600 h) | | | | | |

The hydrotreating test results of distillate (Tables 8 and 9) show that the hydrotreating catalysts using the composite supports containing the silica-group 4 metal oxide of the periodic table of the present invention exhibited superior hydro-desulfurization activity with 140 or more in terms of relative activity and activity stability compared to catalysts using conventional silica-alumina-based supports and catalysts of Comparative Examples.

In addition, since the catalyst of the present invention has high hydro-desulfurization activity, it can be applied to other hydrotreating reactions (hydrogenation, hydrodenitrogenation, hydro-dearomatization, removal of carbon residue through hydrogenation, etc).

From this, it is understood that the catalyst of the present invention has a long catalyst life and can contribute to the improvement of the economic efficiency of the operation of desulfurization units.

1. A hydrotreating catalyst for hydrocarbon oils comprising, at least one metal selected from the group 6 of the periodic table, at least one metal selected from the groups 8 to 10 of the periodic table, and optionally further phosphorus and/or boron as catalytic active components supported on an inorganic porous support based on alumina, wherein the inorganic porous support comprises, as constituent components thereof, silica in an amount of less than 1% by mass with respect to the mass of the oxide and a metal of the group 4 of the periodic table in an amount of less than 13% by mass as an oxide; wherein the metal of the group 4 of the periodic table is highly dispersed in the inorganic porous support, a degree of dispersion thereof is shown by that no peak is substantially observed in the wave number range of 100 to 200 cm⁻¹ by Raman spectroscopy and that no crystal is substantially observed by X-ray diffraction analysis; wherein the hydrotreating catalyst has a specific surface area of 100 to 300 m²/g, a pore volume of 0.2 to 0.5 ml/g, an average pore diameter of 6 to 10 nm, and a NO adsorption amount of 4.5 cm³/ml or more as catalytic characteristics; and wherein no crystals derived from the metal oxide salts of the group 6 of the periodic table are not substantially observed by X-ray diffraction analysis.

2. The hydrotreating catalyst according to claim 1, wherein the supported amount of the metal selected from the group 6 of the periodic table is 15 to 30% by mass and the supported amount of the metal selected from the groups 8 to 10 of the periodic table is 0.5 to 5% by mass based on the catalyst oxide.

3. The hydrotreating catalyst according to claim 1 or 2, comprising 0.5 to 5% by mass of phosphorus and/or boron based on the catalyst oxide.

4. A hydrotreating method of hydrocarbon oils, wherein the hydrogenation catalyst disclosed in any one of claims 1 to 3 is brought into contact with a hydrocarbon oil under conditions of a reaction temperature of 300 to 450° C., a hydrogen partial pressure of 1 to 20 MPa, a liquid hourly space velocity of 0.1 to 10 hr⁻¹, and a hydrogen/oil ratio of 50 to 1,200 Nm³/kl.
